(19) United States
(12) Patent Application Publication
(10) Pub. No.: US 2007/0043487 A1
(43) Pub. Date: Feb. 22, 2007

(54) Method and system for providing vehicle-service alerts to a vehicle technician

(75) Inventors: Carl J. Krzystofczyk, Mount Prospect, IL (US); Jeff B. Grier, Royal Oak, MI (US); Jim J. Cancilla, San Jose, CA (US); Sunil P. Reddy, Corpus Christi, TX (US); Brad Lewis, Gilroy, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Snap-on Incorporated

(21) Appl. No.: 11/208,476

(22) Filed: Aug. 19, 2005

(51) Int. Cl. G01M 17/00; G06F 19/00

(52) U.S. Cl. 701/30; 701/35

(57) ABSTRACT

A method and system for providing vehicle-service alerts to a vehicle technician is disclosed. A technician alert system receives from a vehicle technician information identifying a given type of vehicle scheduled for service. Based on the received information, the technician alarm system determines one or more vehicle-service alerts, if any, for the given type of vehicle. The system then provides the one or more vehicle service alerts to the vehicle technician.

### BACKGROUND

1. Field of the Invention

The present invention generally relates to vehicle service, and more particularly, to methods and systems for providing vehicle-service alerts to vehicle technicians.

2. Description of Related Art

Manufacturers of vehicles produce many different types of vehicles. For example, in automotive industry, manufacturers often develop a new version of each vehicle model each year, with each model typically varying in some way from the previous versions. Thus, vehicle technicians who are tasked with servicing a large number of vehicles must try to keep up with the latest repair and maintenance information for vehicles within a wide range of manufacturers, models, and model years.

This vehicle information changes rapidly. Typically, a vehicle technician will lack time and/or resources to try to discover new relevant information for different types of vehicles that are scheduled to be serviced by the vehicle technician. In addition, the overwhelming volume of potential information makes this task difficult, if not impossible.

Thus, a vehicle technician, who is to work on a given type of vehicle scheduled for service, may often be unaware of known or potential problem(s) with the given type of vehicle. As a result, at the time of vehicle service, the vehicle technician may be forced to re-discover known or potential problem(s) and/or re-invent existing repair techniques. This is costly and time consuming. Further, the vehicle technician may have no prior knowledge of other important service information (e.g., latest vehicle recall(s)) for the given type of vehicle that may be critical to ensure vehicle safety and/or may enhance vehicle performance and reliability.

Thus, a general need exists for providing a vehicle technician with relevant up-to-date vehicle-service information for a given type of vehicle scheduled for service.

### SUMMARY

In one disclosed embodiment, a technician alert system is provided. The technician alert system receives from a vehicle technician information identifying a given type of vehicle scheduled for service. Based on the received information, the technician alarm system determines one or more vehicle-service alerts, if any, for the given type of vehicle. In one example, the technician alarm system uses the information as search criteria for searching a number of vehicle-information sources to determine one or more vehicle-service alerts, if any, for the given type of vehicle. The system then provides the one or more vehicle service alerts to the vehicle technician.

These as well as other aspects and advantages will become apparent to those of ordinary skill in the art by reading the following detailed description, with reference where appropriate to the accompanying drawings.

### BRIEF DESCRIPTION OF THE DRAWINGS

FIG. 1 is a block diagram of a system that can operate in accordance with one disclosed embodiment;

FIG. 2 is a flow chart depicting functions that may be carried out according to the disclosed embodiment;

FIG. 3 is a flow chart depicting functions that may be carried out according to one particular embodiment;

FIG. 4 is a block diagram of a technician alarm system arranged to carry out the functions described herein;

FIG. 5 is a block diagram of one particular arrangement including the technician alarm system of FIG. 1; and

FIG. 6 is one example of a search-results report.

### DETAILED DESCRIPTION OF PRESENTLY DISCLOSED EMBODIMENTS

1. General System Architecture and Operation

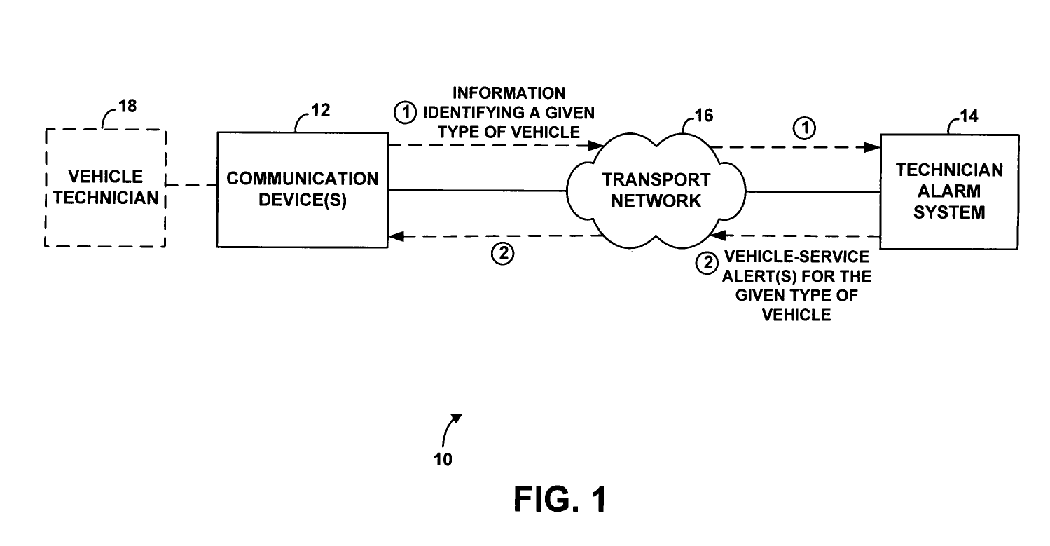

Referring to the drawings, FIG. 1 is a simplified block diagram of an example of a system 10 arranged to provide vehicle-service alerts to a vehicle technician in accordance with one disclosed embodiment. System 10 includes one or more communication devices 12 and a technician alert system 14, coupled by a transport network 16. As such, a vehicle technician 18 (as generally shown in FIG. 1) may communicate with technician alarm system 14 (i.e., may submit/receive information to/from technician alarm system 14) over transport network 16 via one or more communication devices 12. In this regard, a given communication device may be equipped with suitable user interface(s) (e.g., a keypad, a keyboard, a microphone, a display, etc.) to facilitate interaction with the vehicle technician.

It should be understood, however, that this and other arrangements and processes described herein are set forth for purposes of example only, and other arrangements and elements (e.g., machines, interfaces, functions, orders of elements, etc.) can be added or used instead and some elements may be omitted altogether. Those skilled in the art will also appreciate that many of the elements described herein are functional entities that may be implemented as discrete components or in conjunction with other components, in any suitable combination and location, and various functions could be carried out by software, firmware and/or hardware. Further, although the principles of the present application are mainly discussed herein in reference to a car, the principles of the present application are applicable to other types of vehicles, examples of which include trucks, motorcycles, buses, and boats.

As generally depicted in FIG. 1, transport network 16 may be a wireless network, a landline network, or a combination of wireless and landline network(s) interconnected via appropriate interfaces and/or various network elements. In addition, transport network 16 may be a private network, a public network, or a combination of private and/or public networks. As an example, technician alert system 14 may be deployed on a private network (e.g., Snap-on® private network) accessible to a user through a public network, such as the Internet and/or the Public Switched Telephone Network (PSTN), and/or other private/public network(s) (e.g., a wireless carrier's network, local area network (LAN), a wireless 802.11 LAN, etc.)

Communications between the vehicle technician and technician alert system 14 may be in the form of data and/or voice communications and may be established over a variety of connections including cable modem, dial-up, digital subscriber line (DSL), wireless (e.g., wireless broadband, cellular, 802.11, etc.), direct PSTN, and/or other type of connection(s). Accordingly, communication device(s) 12 may include landline computer(s) (e.g., a personal computer), PSTN telephone(s), Voice-over-IP (VoIP) telephone(s), wireless computer(s) (e.g., a laptop), handheld wireless device(s) (e.g. a mobile/cellular phone, a portable diagnostic device, a personal digital assistant (PDA) etc.), and/or the like.

In this regard, a communication method used to submit information to technician alert system 14 may be the same or different from a communication method used to return information from the technician alarm system back to the vehicle technician. As an example, the vehicle technician might prefer to submit information to technician alert system 14 in the form of voice communication via a PSTN telephone or a cellular phone, but might prefer to receive a response from technician alarm system 14 in the form of data communication via another communication device, such as a fax machine or a personal computer. In one embodiment, the vehicle technician may have an option of specifying a selected return communication method.

In the disclosed embodiment, the vehicle technician (or repair shop in general) may submit to technician alert system 14 information identifying a given type of vehicle (e.g., a given make/model/year of vehicle) scheduled for service. In turn, technician alert system 14 may function to determine one or more vehicle-service alerts (if any) for the given type of vehicle and provide the vehicle-service alert(s) to the vehicle technician, e.g., prior to the vehicle technician servicing the given type of vehicle.

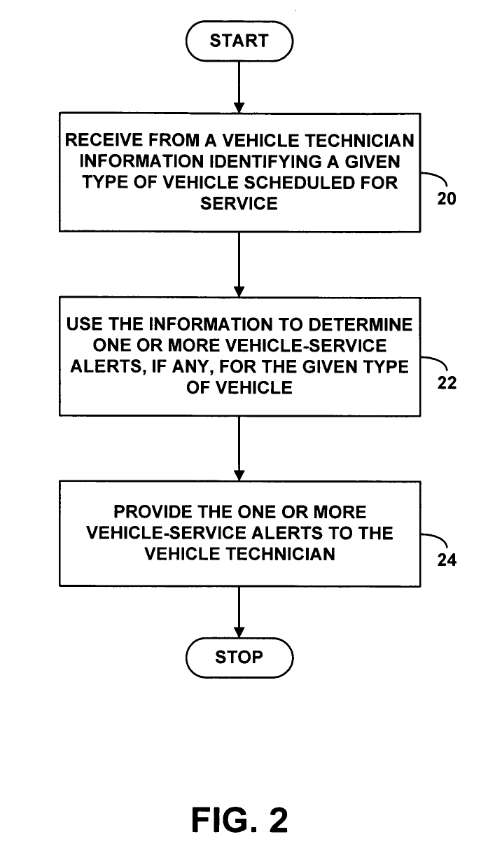

FIG. 2 is a flow chart illustrating a set of functions that could be carried out in accordance with the disclosed embodiment, in the system arrangement of FIG. 1 for instance. In one example, technician alarm system 14 may include a processing system (e.g., implemented in the form of processor(s) and stored program instructions executed by the processor(s)) that could be arranged to carry out such set of functions.

As shown in FIG. 2, at step 20, technician alarm system 14 receives from vehicle technician 18 information identifying a given type of vehicle scheduled for service. At step 22, the technician alarm system uses the information to determine one or more vehicle-service alerts, if any, for the given type of vehicle. Finally, at step 24, the technician alarm system provides the one or more vehicle-service alerts to the vehicle technician.

Advantageously, the vehicle technician could learn of any relevant up-to-date vehicle-service information for the given type of vehicle prior to performing any type of service (e.g., repair or maintenance service) on the given type vehicle. For example, vehicle-service alerts may include latest vehicle recall(s), manufacturer-recommended maintenance schedule information, up-to-date notifications regarding known or potential problems with the given type of vehicle (and possibly solutions to those problems), service recommendations based on recently-identified problems or potential problems with the given type of vehicle, and/or other types of information that the vehicle technician should be alarmed of and/or may benefit from having the knowledge thereof prior to servicing the given type of vehicle.

As one example, with the benefit of having vehicle-service alerts at hand before servicing a vehicle, the vehicle technician could learn of a recently-discovered problem with similar-type vehicles that is consistent with the symptoms described by the vehicle owner. As a result, the vehicle technician could first inspect the vehicle for the problem identified in a vehicle-service alert, without spending unnecessary time trouble-shooting the vehicle and possibly diagnosing a problem that may be already known. This may prove to be time and cost efficient for both the vehicle technician and the vehicle owner.

Further, based on the vehicle-service alerts returned from technician alarm system 14, the vehicle technician could recommend to the vehicle owner to perform additional vehicle service(s) (e.g., a repair based on a recall that was recently issued and/or a maintenance service recommended by a manufacturer) that may improve vehicle performance, reliability and/or safety.

In practice, the vehicle technician may identify a type of vehicle that is scheduled for service with an undetermined number of vehicle attributes that are available to the vehicle technician and/or are considered to be relevant. Some examples of typical vehicle attributes include make/manufacturer, model, model year, mileage, VIN and/or any other kind of identifying information (e.g., an engine type and/or engine size (e.g., a 3.0 L V6, etc.). To illustrate, a given vehicle type may be identified by a combination of a vehicle make, model, and model year. In another example, a given vehicle type may be identified by a combination of a vehicle make, model, model year, and mileage. Various other combinations of vehicle attributes are also possible.

In one embodiment, the vehicle attributes may include an indication of a geographic location associated with a vehicle (e.g., the geographic location in which the vehicle is primarily operated), such as a particular geographic region (e.g., a Midwest region of the U.S.) or a more granular geographic location, such as a particular state, city, etc. This information may be helpful, for example, in identifying problem(s) or indication(s) of potential problem(s) with given type(s) of vehicle(s) within particular geographic location(s).

For instance, a vehicle operated in one geographic location may experience certain problems more often than another vehicle of the same (e.g., having substantially the same combination of attributes, such as the same make and model) or similar type that is operated in another geographic location. The problems may be related to differences in weather/environmental conditions between the two geographic locations, and/or other factors, such as traffic conditions. As one example, a vehicle operated in a geographic area that often experiences extreme temperature conditions may be more likely to have certain component and/or system failures than another vehicle of the same type operated in an area with milder temperature conditions.

In another example, a vehicle operated primarily in a geographic area with heavy-traffic conditions, such as a large metropolitan area with frequent “stop-and-go” traffic, may exhibit certain problems (e.g., brake and/or transmission problems) more often than another vehicle of the same or similar type operated primarily in a rural area where heavy-traffic conditions are rare. Various other examples are also possible.

In general, vehicle attributes identifying a given type of vehicle may be submitted to technician alarm system 14 by the vehicle technician in any of a variety of ways. Some examples include email, fax, a web-based interface, voice phone communication, and/or direct vehicle communication via diagnostic tools. For example, various vehicle attributes might be collected by an appropriately programmed diagnostic device (e.g., a portable device, such as a PDA) when it is connected to a vehicle and may be transmitted to technician alarm system 14 upon connection to transport network 16 (e.g., the vehicle technician may conveniently direct the diagnostic device to transmit the vehicle attributes to the technician alarm system, so as to retrieve any vehicle-service alerts prior to servicing the vehicle).

In another example, technician alarm system 14 may be integrated with an automated voice recognition platform, such that the vehicle technician having an access number to the technician alarm system can conveniently submit vehicle-identifying information through voice communication using, e.g., a PSTN telephone, a VoIP telephone, or a mobile/cellular telephone. A typical voice recognition platform may include an analog-to-digital (A-D) converter for converting an analog speech signal from a user into a digitized incoming speech signal. (Alternatively, the user's speech signal might already be digitized, as in a voice-over-IP communication system, for instance, in which case A-D conversion would be unnecessary).

In yet other example, the vehicle technician may be provided with a URL address of a web page having an interactive user interface that may allow the vehicle technician to enter vehicle-identifying information directly into the interface or by selecting vehicle attributes from a drop-down menu or some other pre-programmed selection means. Similarly, the vehicle technician may have an email address or a fax number of technician alert system 14 and may submit information via fax or email.

In one specific example, vehicle-identifying information may also be submitted to technician alarm system 14 via a suitable software application, such as the ShopKey Shop Management System available from Snap-on Inc., that may be, e.g., running on a computer system at a repair shop. In particular, the ShopKey Shop Management System facilitates management of information at a repair shop, including job scheduling, preparing estimates and repair orders, billing, and other functions. Thus, for instance, vehicle-identifying information can be entered (e.g., directly by the technician assigned to service a vehicle or a repair shop assistant preparing an initial work order for a vehicle) and submitted from a repair shop to technician alarm system 14 via such or similar application interface.

In some embodiments, the process of submitting information identifying a given type of vehicle to technician alarm system 14 may also involve the use of vehicle telematics. As generally known in the art, vehicle telematics relates to data communications between a vehicle and a remote communication system. For instance, in automotive telematics applications, various vehicle-related data may be automatically transferred (typically wirelessly) from a vehicle for monitoring by a remote communication system. Thus, for example, when within the vehicle technician's arena, a telematics-enabled vehicle scheduled for service may wirelessly communicate relevant vehicle attributes for receipt by technician alarm system 14. Variations are possible.

Further, in the disclosed embodiment, information (e.g., vehicle attributes) identifying more than one given type of vehicle may be submitted to technician alarm system 14. For instance, the vehicle technician may check his/her daily work schedule and find out that the vehicle technician has been assigned to service several vehicles that day (e.g., a 2000 Ford® Taurus, a 2002 Ford® Taurus, and a 2004 Honda® Civic). The vehicle technician may thus desire to learn of any vehicle-service alerts for each type of vehicle that he/she will be working on.

In accordance with the disclosed embodiment, the vehicle technician may concurrently submit to technician alarm system 14 information identifying two or more given types of vehicles. For example, each of the two or more given types of vehicles may be identified by a respective set of vehicle attributes that may be submitted to technician alarm system 14. Further, each set of vehicle attributes identifying a given type of vehicle may include any desired number of vehicle attributes.

Vehicle-identifying information for each given type of vehicle (e.g., a set of attributes for each given type of vehicle) may be submitted to technician alarm system 14 in any of a variety of ways as described above. For instance, the vehicle technician could submit vehicle-identifying information for each vehicle type of interest via an automated voice-recognition (phone) service provided at the technician alarm system. In this regard, the automated voice-recognition service may be arranged accordingly to facilitate the process of submitting information for multiple vehicle types (e.g., the vehicle technician may be prompted to provide (via voice) a set of vehicle attributes for each given type of vehicle, pressing a pound sign (#) for instance, to delimit a particular set of vehicle attributes denoting a given vehicle type). Various other examples may also be possible.

When technician alarm system 14 receives vehicle attributes identifying at least one given type of vehicle, the technician alarm system may use the vehicle attributes as search criteria against a number of vehicle-information sources to determine one or more vehicle-service alerts (if any) for the given type of vehicle.

Various vehicle-information sources may include (i) recall notices regarding known vehicle defects and/or suggested service procedures for improving vehicle safety, (ii) manufacturer reference information (e.g., manufacturer-recommended maintenance schedules), (iii) technical service bulletins (TSBs) that are often issued by car manufacturers to assist automotive technicians in diagnosing and repairing problems reported by vehicle owners and/or repair shops (e.g., TSBs may contain up-to-date factory fixes for difficult-to-diagnose problems), (iv) reports of common/known and/or recently-noted problems with various types of vehicles (e.g., as routinely reported by repair shops and compiled by a manufacturer (or, alternatively, by some other third party), (v) retail information (as compiled by a manufacturer or another party) regarding vehicle part sales to repair shops and/or consumers and/or (vi) various other vehicle-information sources that are deemed to be relevant. As one example, technician alarm system 14 may search vehicle-information database available on the OnDemand5 repair system from Mitchell1 that includes updated vehicle maintenance information and TSB information.

In one particular embodiment, technician alarm system 14 may have access to and search regularly-collected information regarding actual problems that have been diagnosed with various types of vehicles. One example mechanism for collecting and storing this type of vehicle information is described in a copending U.S. patent application Ser. No. 11/023,997, titled “Method and System for Enhanced Vehicle Diagnostics Using Statistical Feedback”, to Cancilla et al., filed on Dec. 28, 2004.

Generally, the '997 application describes a diagnostic information portal that receives a request regarding a vehicle problem from a diagnostic device and searches various information sources in order to determine possible causes for the problem. Once the diagnostic information portal accesses the information sources in order to determine the possible causes of the problem, the diagnostic information portal can then send a list or other description of the possible causes back to the diagnostic device for display to a vehicle technician. The list of possible causes may be statistically prioritized to alert the vehicle technician to the more likely causes of the problem.

Further, as disclosed in the '997 application, in addition to receiving requests for information used to diagnose a problem with a vehicle, the diagnostic information portal can also receive information about the problem that was eventually diagnosed with the vehicle. For example, the problem might be stored in the diagnostic device along with identifying information for the vehicle (e.g., its make/model, VIN, or other such information).

The diagnostic device can subsequently report the information about the diagnosed problems back to the diagnostic information portal, which can then use the information to update one or more of the information sources used to diagnose problems. For example, the diagnostic device can report the information about the diagnosed problems in real-time. Thus, the statistical likelihoods that are a part of the information sources used to diagnose problems with vehicles can be updated based on data about the actual occurrences of these problems in vehicles, thereby potentially increasing the accuracy of the statistical likelihoods associated with the various problems.

Thus, in one example, technician alarm system 14 may search the type of up-to-date vehicle-diagnostic information described in the '997 application and may, for example, identify any frequent problem(s) with a given type of vehicle. The technician alarm system 14 may subsequently return vehicle-service alert(s) related to any identified problem(s) with the given type of vehicle, so as to alert the vehicle technician of the occurrence of the known problem(s) with the given type of vehicle. In addition, the vehicle-service alert(s) may include recommended prognostic service procedure(s) for the given type of vehicle based on the identified problems(s). For example, based on an identified problem, a vehicle-service alert may include a recommendation to inspect or test a particular vehicle component or system in advance of potential failure(s).

In one embodiment, upon completion of the search, the technician alert system may gather the search results, create a search-results report including one or more vehicle-service alerts, if any, for each given type of vehicle, and deliver the search-results report back to the vehicle technician. The search-results report may be formatted according to a selected return communication method, e.g., as a fax, an email message, or a web-based report that the vehicle technician could view on-line using any device having connectivity to the web (e.g., a PDA or a personal computer). When the vehicle technician receives the search-results report, the vehicle technician may review the report to learn of any relevant up-to-date vehicle-service information for a given type of vehicle before the scheduled-for-service vehicle is even looked over.

As noted above, vehicle-service alert(s) provided in the search-results report for a given type of vehicle may include latest recall notice(s), manufacturer-recommended maintenance information, up-to-date notification(s) regarding known or potential problems with the given type of vehicle (potentially along with any existing or recommended repair tips/diagnostic tests for those problems), and/or other relevant information. Further, vehicle-service alert(s) may include prognostic information (e.g., service recommendations based on recently-identified problems or potential problems with the given type of vehicle) suggesting to the vehicle technician that components, systems, and/or parts be inspected/checked that otherwise might be overlooked, thus potentially providing a vehicle owner with improved vehicle performance, reliability and/or safety.

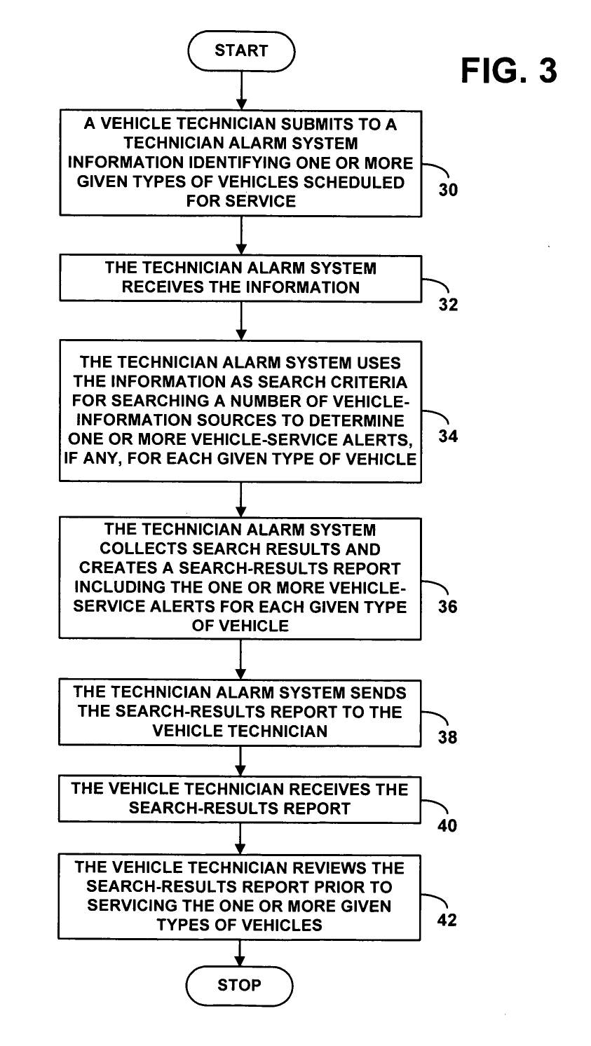

FIG. 3 is a flow chart provided to help summarize a set of functions that could be carried out in accordance with the process described above.

At step 30, a vehicle technician submits to a technician alert system information identifying one or more given types of vehicles scheduled for service. For example, the vehicle technician could submit to the technician alarm system a set of vehicle attributes for each given type of vehicle scheduled for service.

At step 32, the technician alert system receives the vehicle-identifying information. At step 34, the technician alert system uses the vehicle-identifying information as search criteria for searching a number of vehicle-information sources to determine one or more vehicle-service alerts, if any, for each given type of vehicle. At step 36, the technician alert system collects search results and creates a search-results report including the one or more vehicle-service alerts for each given type of vehicle. As noted above, the search-results report may be formatted based on a selected return communication method.

At step 38, the technician alarm system sends the search-results report to the vehicle technician. At step 40, the vehicle technician receives the search-results report. Lastly, at step 42, the vehicle technician reviews the search-results report prior to servicing the one or more given types of vehicles.

2. Technician Alarm System

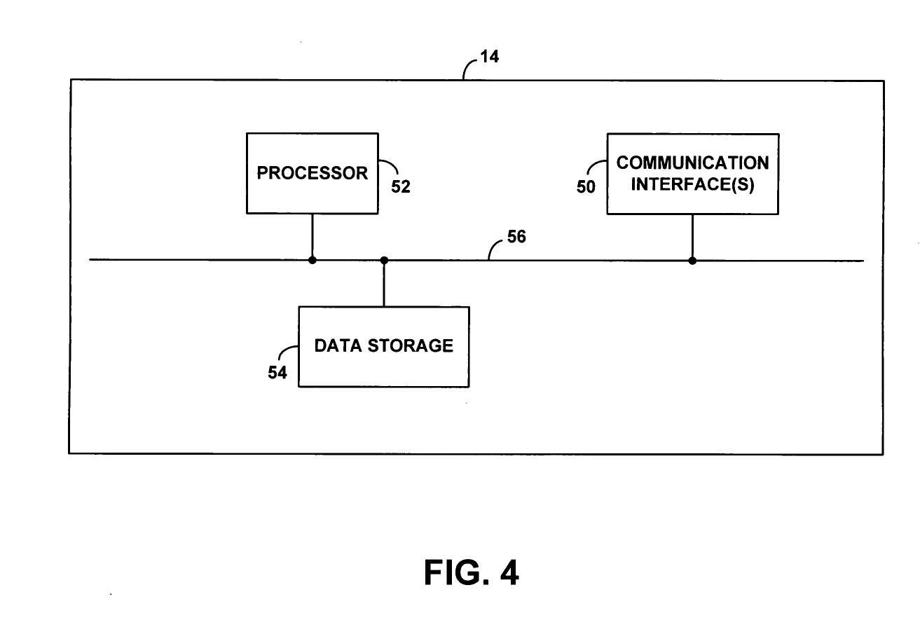

FIG. 4 illustrates technician alarm system 14 of FIG. 1 in greater detail. As depicted in FIG. 2, technician alarm system 14 may include components such as one or more communication interface(s) 50, a processor 52 and a data storage 54, all tied together via a system bus or other mechanism 56.

Note that components depicted in FIG. 2 are shown for purpose of example only and variations are possible. For example, components illustrated in FIG. 2 may be located within a single functional unit or a plurality of functional units. In this regard, for example, data storage 54 may instead be located in a physically separate location from processor 52, with a means for connecting the data storage and the processor. Similarly, the logic functions could be carried out by a single processor or could be divided over distinct entities located in the same functional unit or in physically separate units. Further, technician alarm system 14 may include other components in addition to those depicted in FIG. 2.

For example, technician alarm system 14 may include a voice recognition platform comprising an analog-to-digital (A-D) converter for converting analog speech signals into digitized speech signals and a speech recognition (SR) engine, which functions to analyze the digitized incoming speech signal and to identify words in the speech. The SR engine will typically be a software module (e.g., stored in data storage 54) executable by a processor (e.g., processor 52). One suitable voice recognition platform is a Nuance Voice Platform manufactured by Nuance Communications, Inc., although other types of voice recognition platforms may be also be used.

Processor 52 may be one or more general purpose processors (such as Intel Pentium class processors or better) and/or dedicated processors (such as digital signal processors), and data storage 54 may be any sort of storage, whether volatile and/or nonvolatile. Data storage 54 may hold program logic (e.g. machine language instructions) executable by processor 52 to carry out various functions described herein and/or to store data used by the program logic.

For example, in one embodiment, data storage 54 may store database(s) of various vehicle-information sources that may be searched to determine vehicle-service alerts for different types of vehicles. In other embodiments, some or all of the vehicle-information sources may be stored remotely from the technician alarm system (e.g., on the Internet, on third-party private network(s) and/or on other network element(s) located on the same network as the technician alarm system). The technician alarm system could access the remotely-stored vehicle-information sources via appropriate one or more of communication interface(s) 50. Communication interface(s) 50 may include suitable wired and/or wireless interfaces for various types of communications, including communications to/from communication devices used by vehicle technicians to communicate with technician alarm system 14.

Further, in an example embodiment, various (local and/or remote) vehicle-information sources used by technician alarm system 14 may be actively maintained and updated with latest vehicle information. The updates may be done periodically or on an on-going basis as new and/or updated vehicle information becomes available. Further, the updates may done manually or automatically. Combinations of automated and manual methods are also possible.

In order to determine vehicle service alerts for a given type of vehicle, technician alert system 14 may search various vehicle-information sources in a variety of different ways. In general, when technician alert system 14 receives a set of vehicle attributes identifying a given type of vehicle, the technician alarm system (e.g., processor 52 executing an appropriate program logic (e.g., an SQL application) stored in data storage 54) may use the set of vehicle attributes as search parameters to search available vehicle-information sources. In this regard, technician alert system 14 may use all and/or any subset/combination of the vehicle attributes as search parameters.

In one example, the technician alarm system might use the set of vehicle attributes to search each vehicle-information source (e.g., recall information, manufacturer reference information, and/or other vehicle-information sources described above) for relevant information that applies to the given type of vehicle. (Note that if the technician alert system receives multiple sets of vehicle attributes identifying multiple vehicle types, the same search process may be repeated for each set of vehicle attributes). The technician alert system might search each vehicle-information source based on all of the vehicle attributes in the set and/or various combinations of the vehicle attributes.

In some cases, identifying a given type of vehicle with a greater number of vehicle attributes may narrow the scope of search results collected by technician alarm system 14. In other cases, some information will apply to different types of vehicles that have a number of the same attributes in common.

For example, recall information will typically apply to all vehicle types having at least the same make, model, and model year (e.g., all 2003 Toyota® Corollas), regardless of other attribute(s) (e.g., mileage and/or geographic location) that are submitted to the technician alarm system. Similarly, TSB information may apply to all vehicle types having at least the same make, model, and model year (e.g., all 2001 Infiniti® 130s), regardless of other attribute(s) (e.g., geographic location) that are submitted to the technician alarm system. Thus, technician alarm system 14 may be programmed accordingly to collect and return any such type of information.

Once technician alert system 14 completes the search, the technician alarm system may create a search-results report including vehicle-service alert(s) for each of one or more types of vehicles that were submitted to the technician alarm system. The search results report can take any of a variety of forms. For instance, for each given type of vehicle, vehicle-service alerts may be organized into different informational groupings (e.g., recall-related alerts, maintenance-related alerts, prognostic-related alerts, etc.) that could let a vehicle technician quickly identify different alert categories.

As one example, the vehicle technician could browse through the TSB-category (e.g., the TSB titles) included in the search-results report to determine if a problem described by a vehicle owner has been identified by a manufacturer in one of the released TSBs. If the vehicle technician notes a particular TSB that relates to the problem, the vehicle technician might refer to that TSB prior to servicing a vehicle to learn if the vehicle manufacturer has recommended any diagnostic procedure(s) for fixing the problem. Various other examples are possible as well.

Further, as noted above, the search-results report may be formatted according to a given return communication method that may be selected by a vehicle technician. For example, the vehicle technician may have an option to specify return communication method(s) by which the vehicle technician wishes to receive the search-results report. The vehicle technician may further specify other information that may be needed to send the search-results report to the vehicle technician using the selected communication method (e.g., a technician's email address or a fax number of the technician's repair shop)). Otherwise, the technician alarm system may use a default communication method to return the search-results to the vehicle technician. Technician alarm system 14 may store, e.g., in data storage 54 appropriate program logic to generate the search-result report in any desired format for presentation to the vehicle technician. Further, the search-results report may be sent to the vehicle technician via communication interface(s) 50.

### 3. EXAMPLE APPLICATION

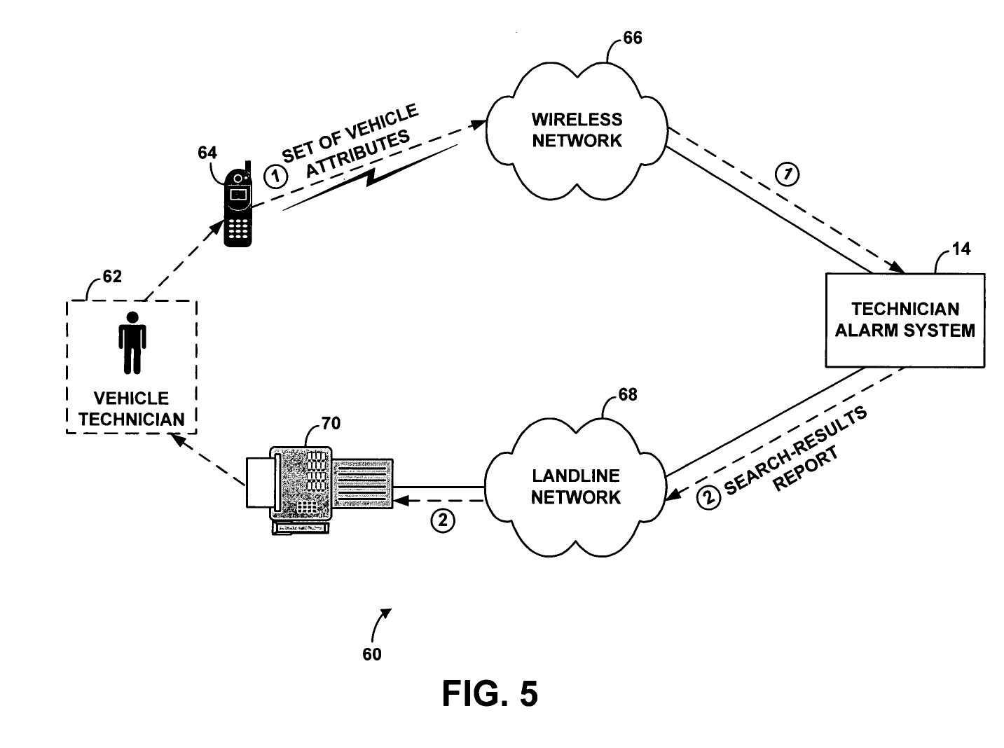

FIG. 5 is a simplified block diagram of one particular arrangement 60 including technician alarm system 14 of FIG. 1 to help illustrate one example application of the principles described herein.

In one illustrative example, a vehicle technician 62 may learn that he/she will be working on a 1998 Toyotas® Corolla with 41,000 miles, operated in Phoenix, Ariz., that is scheduled for an oil change.

Vehicle technician 62 may submit this information (e.g., as a set of vehicle attributes) to technician alarm system 14 through an automated voice-recognition phone service. For example, as shown in FIG. 5, vehicle technician 62 may submit this information to technician alarm system 14 using a mobile phone 64 that can communicate with technician alarm system 14 over a wireless network 66.

When technician alarm system 14 receives from vehicle technician 62 the information identifying the type of vehicle that the vehicle technician will be servicing, the technician alarm system may use this information as search criteria to determine vehicle-service alerts (if any) for this type of vehicle.

As a result of the search based on the information submitted by vehicle technician 62, technician alarm system 14 may discover several vehicle-service alerts for this type of vehicle. For instance, the technician alarm system may discover that the vehicle manufacturer suggests (i) a coolant flush as a part of normal maintenance, (ii) an air filter check due to recent repairs performed on 40,000-60,000 mile vehicles in the southwest U.S., (iii) a replacement of the mass air flow sensor due to a manufacturer recall that was recently issued, and (iv) a battery test based on a recent spike in battery sales to repair shops that repair a high volume of 1998 Toyota vehicles.

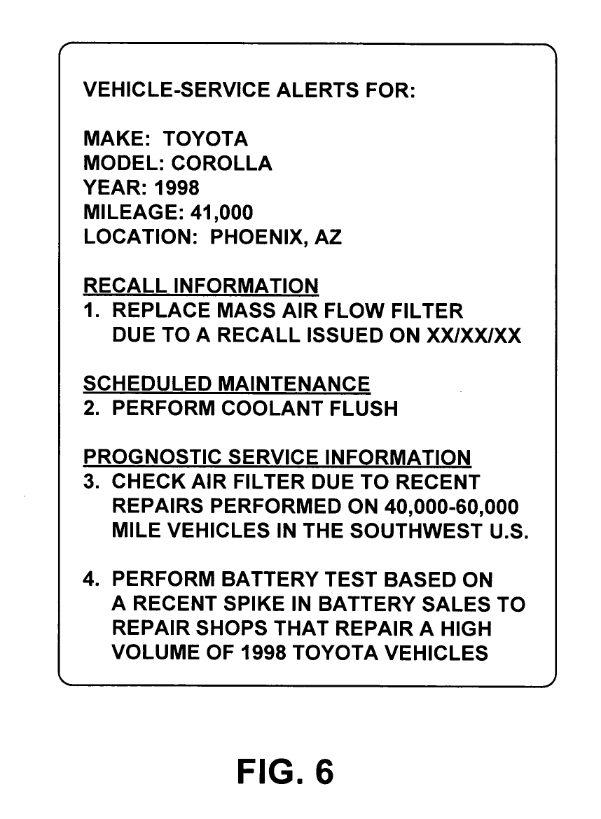

Technician alarm system 14 may use this search-results information to create a search-results report and return the search-results report to vehicle technician 62. For example, as shown in the arrangement of FIG. 5, technician alarm system 14 may fax the search-results report over a landline network 68 to a fax machine 70 that may be located at the technician's repair shop. FIG. 6 illustrates one example of the search-results report that may be faxed by technician alarm system 14. Vehicle technician 62 may then review the search-results report received from technician alarm system 14 prior to servicing the vehicle. (Note: the preceding example is entirely fictional and is only provided for illustration purposes.) As a result, the vehicle, which came in for a regular oil change, may be preventatively examined (and potentially repaired) in advance of component failures, and may have manufacturer recall repairs and recommended maintenance performed all in the same visit, saving vehicle owner time and enhancing vehicle performance, safety, and/or reliability.

### 4. CONCLUSION

Embodiments of the present application have been described above. Those skilled in the art will understand, however, that changes and modifications may be made to these embodiments without departing from the true scope and spirit of the present application, which is defined by the claims. Further, the examples in the above description and figures are set forth in the context of a vehicle technician/repair shop, but the described method and system could be used by any user and not only those described in the above examples.

We claim:

1. A method for providing vehicle-service alerts to a user, the method comprising:
receiving from a user information identifying a given type of vehicle scheduled for service;
using the information to determine one or more vehicle-service alerts, if any, for the given type of vehicle; and
providing the one or more vehicle-service alerts to the user.

2. The method of claim 1, wherein the service includes repair service.

3. The method of claim 1, wherein the service includes maintenance service.

4. The method of claim 1, wherein the information identifying the given type of vehicle includes a set of vehicles attributes.

5. The method of claim 4, wherein the set of attributes includes a vehicle make, a vehicle model, a vehicle model year, or a vehicle mileage.

6. The method of claim 4, wherein the set of attributes includes a geographic location of a vehicle.

7. The method of claim 6, wherein the one or more vehicle-service alerts are based at least in part on the geographic location of the vehicle.

8. The method of claim 1, wherein the one or more vehicle-service alerts include prognostic information.

9. The method of claim 8, wherein the prognostic information includes information recommending to the user one or more vehicle service procedures.

10. The method of claim 1, wherein the one or more vehicle-service alerts include diagnostic information.

11. The method of claim 1, wherein the one or more vehicle-service alerts include maintenance information.

12. The method of claim 1, wherein receiving from the user information identifying the given type of vehicle includes receiving the information via a voice recognition system.

13. The method of claim 1, wherein using the information to determine one or more vehicle-service alerts, if any, for the given type of vehicle includes:
using the information as search criteria for searching a number of vehicle-information sources to determine the one or more vehicle-service alerts.

14. The method of claim 13, wherein the number of vehicle-information sources include up-to-date vehicle information.

15. A technician alarm system for providing vehicle-service alerts to a vehicle technician, comprising:
a processor;
a data storage; and
program logic stored in the data storage and executable by the processor to (i) receive from a vehicle technician information identifying a given type of vehicle scheduled for service, (ii) use the information to determine one or more vehicle-service alerts, if any, for the given type of vehicle, and (iii) provide the one or more vehicle-service alerts to the vehicle technician.

16. The system of claim 15, wherein the processor further executes the program logic to create a search-results report, the search-results report including the one or more vehicle service alerts.

17. A method for providing vehicle-service alerts to a vehicle-technician, the method comprising:
receiving information identifying one or more given types of vehicles scheduled for service, wherein the information includes a set of vehicle attributes for each given type of vehicle scheduled for service;
using the set of vehicle attributes for each given type of vehicle as search criteria for searching a number of vehicle-information sources to determine one or more vehicle-service alerts, if any, for each given type of vehicle;
creating a search-results report including the one or more vehicle-service alerts for each given type of vehicle; and
sending the search-results report for presentation to a vehicle technician.

18. The method of claim 17, wherein the one or more given types of vehicles scheduled for service include at least two given types of vehicles.

19. The method of claim 17, wherein the search-results report is formatted according to a communication method selected for sending the search-results report to the vehicle technician.

20. The method of claim 17, wherein receiving information identifying the one or more given types of vehicles scheduled for service includes receiving the information via vehicle telematics.
